(19) United States
(12) Patent Application Publication
(10) Pub. No.: US 2026/0110706 A1
(43) Pub. Date: Apr. 23, 2026

(54) NEAR-WALL VELOCIMETRY PROBE USING OPTICAL FIBER BUNDLES

(71) Applicant: The George Washington University, Washington, DC (US)

(72) Inventors: Charles Fort, Washington, DC (US); Philippe M. Bardet, Washington, DC (US)

(73) Assignee: The George Washington University, Washington, DC (US)

(21) Appl. No.: 19/362,962

(22) Filed: Oct. 20, 2025

Related U.S. Application Data
(60) Provisional application No. 63/709,296, filed on Oct. 18, 2024.

(51) Int. Cl. G01P 5/20; G01N 21/53; G01N 21/64

(52) U.S. Cl. CPC G01P 5/20; G01N 21/53; G01N 21/64; G01N 2201/08

(57) ABSTRACT

A near-wall velocimetry probe includes a probe body configured for flush mounting on a surface, at least one tracer source mounted to or integrated within the probe body, at least one fiber bundle mounted to or integrated within the probe body, and at least one detector optically coupled to the at least one fiber bundle. The at least one fiber bundle is configured to capture optical signals from the tracers. The probe may include an illumination source embedded within the probe body and optical filters coupled to the fiber bundle. Methods for measuring near-wall flow velocity using the probe and systems for near-wall velocimetry are also provided.

### RELATED APPLICATION

This application claims the benefit of priority of U.S. Provisional Application No. 63/709,296 filed on October 18, 2024, including the references cited therein, the entire content of which is relied upon and incorporated herein by reference in its entirety.

### BACKGROUND

Velocimetry is a critical technique for measuring fluid flow velocities in various scientific and industrial applications. Accurate measurement of flow velocities, especially near solid boundaries, or walls, is essential for understanding fluid dynamics, optimizing processes, and improving designs in fields such as aerospace, automotive engineering, and chemical processing.

Currently, there is no commercially available velocimeter probe specifically designed for near-wall measurements. Instead, expert experimentalists typically rely on complex and expensive laser-based velocimetry systems to resolve the flow at the wall. Such techniques include molecular tagging velocimetry (MTV), particle tracking velocimetry (PTV), particle image velocimetry (PIV), laser Doppler velocimetry (LDV), among others. Traditional velocimetry methods often struggle to provide accurate measurements in the near-wall region of fluid flows. This region, typically within a few millimeters of a solid boundary, is characterized by rapid changes in velocity and complex flow structures. Existing techniques like PIV or LDV can be challenging to implement in confined spaces or near surfaces, and may lack the spatial resolution needed to capture fine details of near-wall flows.

Furthermore, many conventional velocimetry systems require complex optical setups, precise alignment, and careful calibration. These requirements can make such systems impractical for use in industrial settings or harsh environments where robustness and ease of deployment are crucial. There is a growing need for velocimetry solutions that can be easily integrated into existing systems and provide reliable measurements in a wide range of operating conditions.

The ability to measure near-wall flow velocities accurately and non-intrusively is particularly important for studying boundary layer phenomena, heat transfer processes, and surface interactions in fluid systems. However, achieving this without disturbing the flow or requiring extensive modifications to the system under study remains a significant challenge in the field of fluid mechanics and measurement technology.

As industrial processes become more sophisticated and efficiency requirements more stringent, there is an increasing demand for compact, versatile, and user-friendly velocimetry tools. Such tools would ideally combine high measurement accuracy with the ability to operate in diverse environments, from laboratory settings to industrial production lines.

### SUMMARY

It would be invaluable for practical and industrial applications to have a probe that can be mounted on a surface boundary and measure local streamline patterns, near-wall velocity profiles, and wall shear stress.

According to an aspect of the present disclosure, a near-wall velocimetry probe is provided. The near-wall velocimetry probe includes a probe body configured for flush mounting on a surface. The probe includes at least one tracer source mounted to or integrated within the probe body. The probe further includes at least one fiber bundle mounted to or integrated within the probe body downstream of the tracer source. The probe also includes at least one detector coupled to the at least one fiber bundle, wherein the at least one fiber bundle is configured to capture the tracers’ optical signature issued from the tracer source.

According to other aspects of the present disclosure, the near-wall velocimetry probe may include one or more of the following features. At least one fiber bundle may be arranged in a configuration comprising any one or more of a circle, multiple concentric circles, a line, an arc, and an array. The tracers may be selected from the group of physical filaments, chains of beads, gas bubbles, liquid droplets, dye patches, particles, and naturally present tracers in the flow. The probe may further include an illumination source configured to illuminate the tracers. The illumination source may be embedded within the probe body. The illumination source may comprise fiber optics integrated into the at least one fiber bundle. The probe may further include at least one optical filter coupled to the at least one fiber bundle, wherein the at least one optical filter is configured to selectively transmit the tracers’ optical signature.

According to another aspect of the present disclosure, a method for measuring near-wall flow velocity is provided. The method includes introducing tracers into a flow at a fixed location on a surface. The method further includes capturing the tracers’ optical signature using at least one fiber bundle disposed downstream of the fixed location. The method also includes analyzing the captured light to determine flow velocity near the surface.

According to other aspects of the present disclosure, the method may include one or more of the following features. The tracers may comprise any one or more of physical filaments, chains of beads, gas bubbles, liquid droplets, dye patches, and particles. Capturing the tracers’ optical signature may comprise using at least one fiber bundle arranged in a configuration comprise any one or more of a single circle, multiple concentric circles, a line, an arc, and an array. The method may further include illuminating the tracers using an illumination source embedded within a probe body. The illumination source may comprise fiber optics integrated into the at least one fiber bundle. The method may further include filtering the captured light using at least one optical filter coupled to the at least one fiber bundle. Analyzing the captured light may comprise determining flow direction and magnitude based on the unfiltered or spectrally filtered light captured by the at least one fiber bundle.

According to another aspect of the present disclosure, a system for near-wall velocimetry is provided. The system includes a probe body configured for flush mounting on a surface, which may contain an element to correct for local curvature. The system further includes a tracer source mechanism mounted to or integrated within the probe body. The system also includes a plurality of optical fibers arranged in a pattern on the probe body downstream of the tracer source mechanism. The system additionally includes an imaging device coupled to the plurality of optical fibers, wherein the imaging device is configured to capture images of tracers moving with a flow near the surface.

According to other aspects of the present disclosure, the system may include one or more of the following features. The pattern of optical fibers may comprise at least one configuration that comprise any one or more of a single circle, multiple concentric circles, a line, an arc, and an array. The tracer source mechanism may be configured to introduce tracers that comprise any one or more of physical filaments, chains of beads, gas bubbles, liquid droplets, dye patches, and particles. The system may further include an illumination source embedded within the probe body and configured to illuminate the tracers. The illumination source may comprise fiber optics integrated into the plurality of optical fibers. The system may further include at least one optical filter coupled to the plurality of optical fibers, wherein the at least one optical filter is configured to selectively transmit the tracers’ optical signature.

### BRIEF DESCRIPTION OF THE FIGURES

The accompanying drawings are incorporated in and constitute a part of this specification. It is to be understood that the drawings illustrate only some examples of the disclosure, and other examples or combinations of various examples that are not specifically illustrated in the figures may still fall within the scope of this disclosure. Examples will now be described with additional detail through the use of the drawings, in which:

FIG. 1 is a cross-sectional view of the near-wall velocimetry device in accordance with an example embodiment of the disclosure;

FIG. 2A is a top view of the device showing a single ring of fiber optics;

FIG. 2B is a top view of the device showing two rings of fiber optics;

FIG. 3 is a side cross-sectional view of the device having a filament or string tracer;

FIG. 4 is a block diagram of a beam splitter to direct light between the light source, imager, and fiber optics; and,

FIG. 5 is side view of another embodiment of the imager and light source arranged with respect to the probe body.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in a similar manner to accomplish a similar purpose. Several embodiments are described for illustrative purposes, it being understood that the description and claims are not limited to the illustrated embodiments, and other embodiments not specifically shown in the drawings may also be within the scope of this disclosure.

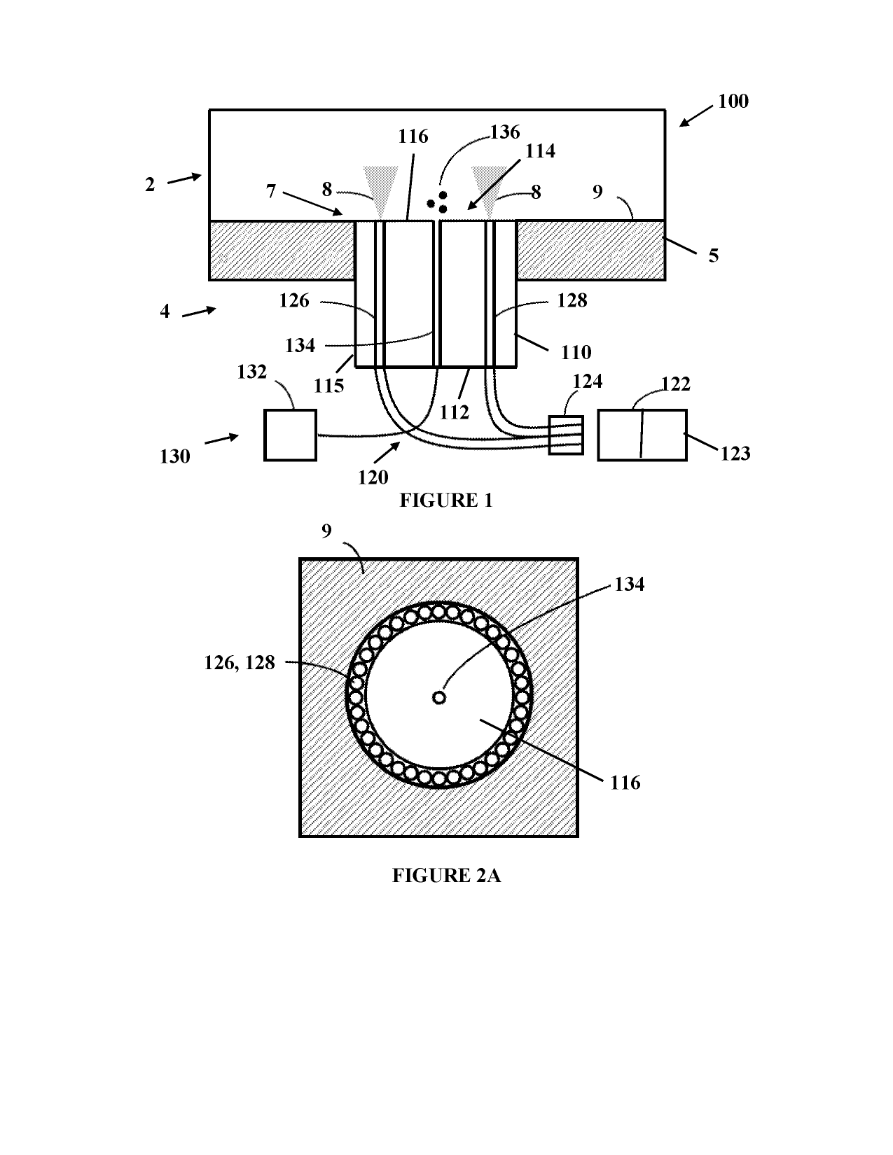

Turning to the drawings, FIG. 1 shows a wall-mounted device 100, in accordance with one non-limiting example embodiment of the present disclosure. The probe 100 includes a housing body 110, an optical system 120, and a tracer or marker system 130.

In the example embodiment shown, the wall-mounted device 100 is mounted to a wall 5 having a wall opening 7 and a wall inner surface 9, for near-wall velocimetry. The wall 5 defines a wall inner side 2 and a wall outer side 4, and the inner surface 9 is at the inner wall side 2 of the wall 5. In one embodiment, the wall-mounted device is a probe 100 which is mounted flush with the wall inner surface 9 to measure near-wall flow velocity at the wall inner surface 9. As shown, the wall 5 is linear, though in other embodiments the wall 5 need not be linear but, for example, can be curved or have an irregular shape.

### Housing Body 110

The housing body 110 has a body proximal end 112, a body distal end 114, and at least one side or side wall 115. The distal end 114 has a body front surface 116 that is orthogonal to the body side wall 115. The body 110 can be elongated, as shown, whereby the body side wall 115 extends longitudinally and the front surface extends transversely.

The probe housing body 110 is sized and shaped to fit in the wall opening 7. The housing body 110 can have any suitable shape, such as having a round or square cross-section. In some embodiments, the housing is machined or molded using corrosion-resistant materials such as stainless steel, anodized aluminum, or clear polymers, allowing for durability in harsh environments, while supporting scalable manufacturing. The compact form factor and flush-mount design allow the probe to be integrated directly into test platforms, ducts, or piping systems with minimal disturbance to the surrounding flow field. This design enables truly non-intrusive flow measurement by eliminating protrusions, discontinuities, or sensor obstructions within the fluid domain.

The housing body 110 can be mounted to the wall in any suitable manner; for example, the probe housing body 110 can be externally threaded about an external body wall surface of the side wall 115 at the probe distal end 114, and threadably mate with internal threads at the wall opening 7. Alternative mounting schemes may include press-fit, bayonet, flanged, or gasket-sealed interfaces, enabling compatibility with a wide range of platforms and installation geometries. As shown, the probe body 110 can be longer than the thickness of the wall 5, so that the probe body 110 extends from the outer wall side 4 through the wall opening 7 so that the probe front surface 116 is flush with the inner wall surface 9 of the wall 5. A gasket or sealing ring (O-ring) may be included around the distal end to ensure leak-tight operation under pressure or in chemically aggressive environments.

The probe proximal end 112 extends outward from the wall rear surface at the wall outer side 4. In that manner, the body 110 can be easily inserted into and removed from the wall opening 7, such as by rotating the body 110 with respect to the wall 5 to threadably mate. This modular configuration allows for rapid deployment, servicing, or replacement of sensing modules without the need for system disassembly. The rear-facing end may also include standardized electrical or optical connectors to facilitate plug-and-play integration with data acquisition systems or imaging equipment. However, the body 110 can be shorter than the thickness of the wall 5, so that the body proximal end 112 is recessed with the wall outer surface at the wall outer side 4, or the body 110 length can be the same as the thickness of the wall 5, so that the body proximal end 112 is flush with the wall outer surface. This modular and scalable design enables integration across a wide range of surface geometries, scales, and applications, including laboratory, industrial, and field deployments.

### Optical System 120

The optical system 120 includes an (optional) illuminator or light source 122, an imager 123, a fiber optic faceplate 124, a first set of one or more illuminating optical fibers 126, and a second set of one or more detecting optical fibers 128. The first set of optical fibers 126 projects light from the light source 122 into an illuminated area 8. And, the second set of detecting optical fibers 128 is configured to collect light originating from the illuminated area 8, wherein the light is reflected, scattered, or re-emitted by the tracers 136 that may be located at or near the wall inner surface 9, and to transmit the collected light to an optical detector 123. The optical configuration provides a compact and optically efficient system for capturing localized tracer motion with minimal intrusion into the flow domain.

The light source or illuminator 122 is provided at the wall outer side 4 and at the probe body proximal end 112. In some aspects, the illumination required for the operation of the near-wall velocimetry probe may be provided by an external source illuminator 122. The illuminator 122 may be, for example, a light source that is separate from the probe, such as a lamp, a laser, or a light-emitting diode (LED). These sources may be fiber-coupled to the probe for modular integration and remote operation. The light from the illuminator 122 may be directed towards the probe domain, illuminating the tracers in the flow. The external source may be capable of providing light across a broad range of the light spectrum, including visible, ultraviolet (UV), and infrared (IR) light. The choice of light spectrum may depend on the specific requirements of the application, such as the properties of the tracers or the fluid, the operating temperature, or the desired resolution of the measurements. For example, UV or IR sources may be chosen to excite fluorescence in dye-based tracers or to exploit absorption contrasts for depth-resolved sensing.

In some cases, the illumination may be embedded within the probe. This may involve the use of fiber optics or separate illumination elements that are integrated into the probe. The fiber optics may be used to deliver light from a source to the probe domain, illuminating the tracers in the flow. The separate illumination elements may be light sources that are incorporated into the probe, such as miniature lamps, lasers, or LEDs. The probe domain illumination can be provided by an external source or embedded within the probe. Embedded illumination supports truly compact, field-deployable probes with reduced reliance on external optics. These embedded illumination options may provide the advantage of a compact design, reducing the overall size of the probe and making it easier to install and use. Such configurations also improve ruggedness for use in harsh environments, such as industrial, marine, or biomedical systems.

In the example embodiment shown, a fiber optic faceplate or adapter 124 is utilized, having a faceplate proximal end with a faceplate proximal surface that faces the illuminator 122 and the imager 123, and a faceplate distal end with a faceplate distal surface that faces opposite the faceplate proximal surface. The optical faceplate 124 is aligned with the illuminator 122 to receive light emitted from the illuminator 122 at the faceplate proximal surface and direct the light into the first set of one or more optical fibers 126. The fibers of the first and second sets of optical fibers 126, 128 have a fiber proximal end and a fiber distal end. The fiber proximal ends are received by the faceplate 124, such as through the faceplate distal end.

The fiber distal ends extend through the probe body proximal end 112, and through the probe housing body 110, to the probe body distal end 114. The fiber distal end has a fiber forward surface, which aligns to be flush with the probe distal surface and wall inner surface 9. In other embodiments, the fiber distal surface can be recessed with respect to or extend outward from, the wall inner surface 9. The optical fibers 126, 128 can be mounted to the interior of the probe housing 110 in any suitable manner. For example, the housing body 110 can be hollow to form a tube with a central opening, and one or more fastening mechanisms can removably or fixedly couple the optical fibers 126, 128 to the probe body inside wall. The fastening mechanism can be, for example, a clamp, clip, adapter, support, adhesive or the like. In another embodiment, the probe body 110 can be solid with a first bore that receives the first optical fibers 126, and a second bore that receives the second optical fibers 128. The bores can extend the full length of the housing body 110, from the housing body proximal end 112, to the housing body distal end 114. The use of high numerical aperture or graded-index fibers may be employed to optimize optical coupling efficiency, spatial resolution, and light collection sensitivity.

Thus, the optical fibers 126, 128 extend from the faceplate 124 to the housing body proximal end 112, through the entire length of the housing body 110, to the housing body distal end 114. The light can be delivered through the first set of optical fibers 126 or separately, and can span a broad range of the light spectrum, including visible, UV, and IR light. The light travels between the illuminator 122, through the first optical fibers 126 to the first fiber distal ends, and projects outward from the first fiber distal end surface as the illuminated area 8. The field of view and illumination geometry may be tailored based on the angular distribution of fibers and the desired measurement region.

In some aspects, the probe may also include one or more optical image detectors or imagers 123. These imagers 123 may be used to capture images of the tracers as they move with the flow. The images captured by the imagers 123 may then be analyzed to determine the velocity of the flow at the surface boundary. The imagers may be of various types, including but not limited to, charge-coupled devices (CCDs), complementary metal-oxide-semiconductor (CMOS) sensors, or photomultiplier tubes (PMTs). In some embodiments, event-based sensors or high-speed photodiode arrays may be used to capture transient or high-frequency flow phenomena. The second set of one or more optical fibers 128 receives light at the second distal end surface, that is scattered, re-emitted, or back-reflected from the tracers 136, and delivers the collected light, via the faceplate 124, to the optical imager 123.

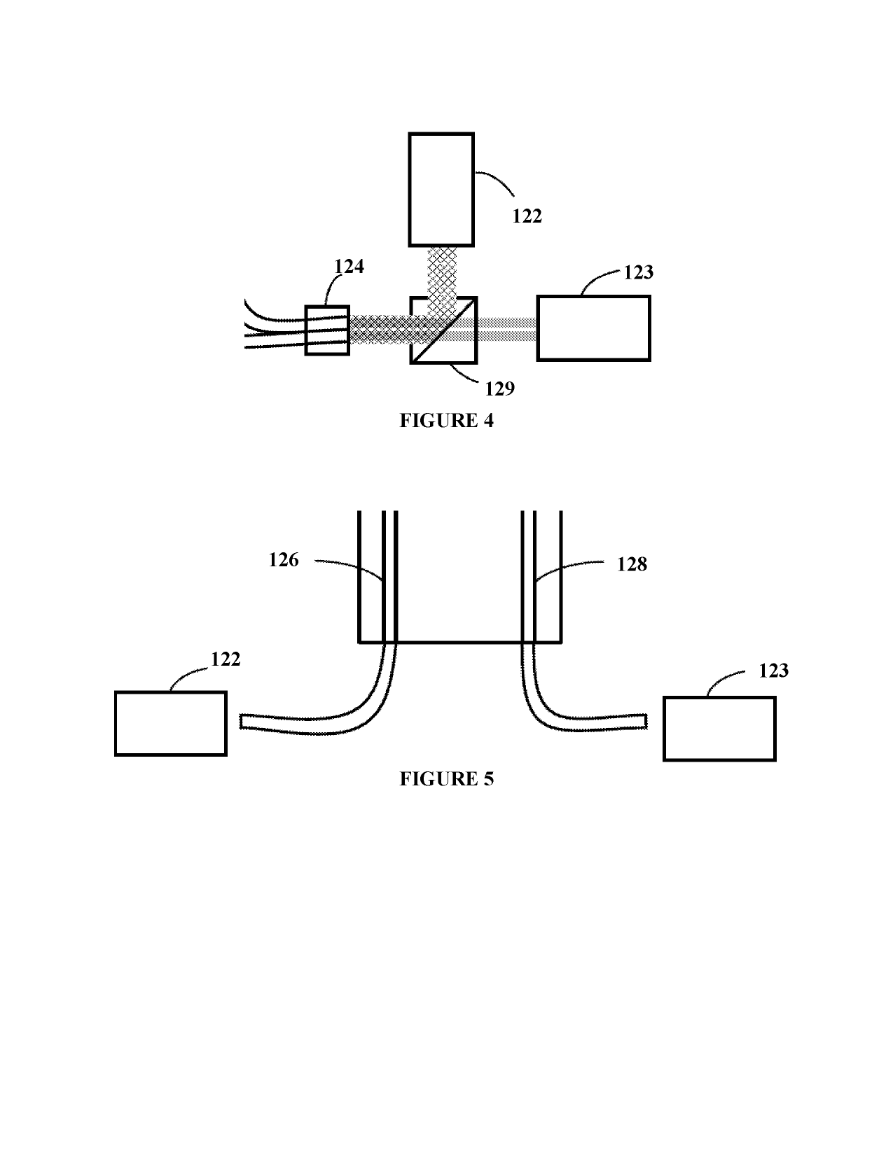

As shown in FIGS. 1-3, the light source 122 and the imager 123 can be integrally located in the same component. FIG. 4 shows another example embodiment of the disclosure, where the light source 122 is a separate component from the imager 123. Here, a dichroic beamsplitter 129 (e.g., mirror) is provided between the fiber optic faceplate 124 and the light source 122 and the imager 123. Thus, light passes out from the light source 122 to the beamsplitter 129, which directs the light (e.g., 90 degrees) toward the faceplate 124 where the light enters the first fiber optics 126. Collected light received from the second fiber optics 128 exits the faceplate 124 and passes to the beamsplitter 129. The beamsplitter 129 allows the received collected light to pass straight through to the imager 123. This configuration enables shared optical paths and compact packaging, reducing the number of discrete optical components.

FIG. 5 shows yet another example embodiment of the light system 120. Here, the light source 122 is separate from the imager 123, and does not share a beamsplitter. The light source 122 transmits light directly into the first optical fibers' proximal ends 126. And, the imager 123 directly receives light from the second optical fibers' proximal ends 128. Optionally, a first optical faceplate or optical component (e.g., lens) can be placed between the light source 122 and the first fibers 126 to facilitate light transmission from the light source 122 to the first fibers 126; and a second optical faceplate or optical component (e.g., lens) can be placed between the second fiber optics 128 and the imager 123 to facilitate light transmission from the second fibers 128 to the imager 123. Such modular arrangements allow customization of the optical system for specific spectral bands, measurement geometries, or deployment constraints.

### Tracer System 130

The tracer system 130 includes a tracer source 132, a tracer injector 134, and one or more tracers 136. The tracer source 132 can be a container or the like. The injector 134 has an injector proximal end and an injector distal end with an injector distal surface. The injector proximal end is coupled with and in flow communication with the tracer source 132. The injector distal end extends from the tracer source 132, through the probe body proximal end 112, and through the probe housing body 110, to the probe body distal end 114. The injector distal end has an injector forward surface, which aligns to be flush with the probe distal surface and wall inner surface 9. In other embodiments, the injector distal surface can be recessed with respect to or extend outward from the wall inner surface 9. The injector 134 can be mounted to the interior of the probe housing 110 in any suitable manner. For example, the housing body 110 can be hollow to form a tube with a central opening, and one or more fastening mechanisms can removably or fixedly couple the injector 134 to the probe body inside the wall. The fastening mechanism can be, for example, a clamp, clip, adapter, support, adhesive, or the like. In another embodiment, the probe body 110 can be solid with an injector bore that receives the injector 134. The bore can extend the full length of the housing body 110, from the housing body proximal end 112, to the housing body distal end 114. For commercial integration, the injector may alternatively be implemented as a minimally invasive hole or port through the wall, formed using precision techniques such as laser drilling or micro-machining, to preserve the non-intrusive nature of the system and minimize flow disruption. Such modular construction allows for simplified assembly and replacement of the tracer module, facilitating field servicing or reconfiguration for different tracer types or flow conditions.

The tracer 136 can be any element or feature that can be optically detected, for example, by light reflected, scattered, or emitted via processes such as phosphorescence or fluorescence. For example, the tracer 136 can be one or more filaments (e.g., physical hair-like structures such as wool or polymers) (FIG. 3), strings or chains of beads (e.g., solid beads or biological cells), gas bubbles, liquid droplets, dye structures (e.g., translucent filaments or dye patches), suspended particles, or naturally occurring tracers present in the flow. To ensure reliable optical detection and flow fidelity, suitable tracers may include commercially available microspheres, dyed polymers, or functionalized nanoparticles tailored for fluorescence, phosphorescence, or scattering. Injection and seeding can be achieved using established systems such as aerosol generators for sub-micron particles (common in PIV/LDV), dye or smoke injectors for qualitative flow visualization, and precision delivery systems, including syringe pumps, pressure-driven loops, or metering valves for controlled droplet or particle injection. The choice of tracer and delivery method can be optimized for the operational environment, ranging from laboratory setups to industrial and biomedical applications.

The tracer 136 is configured by properties such as size, weight, and buoyancy, to follow or conform to the flow or motion of a substance present at the wall inner surface 9, including but not limited to fluids (liquids or gases), solids (e.g., particulates), gels, emulsions, foams, slurries, or other single-phase or multiphase media. Such flows may occur in a wide variety of test and operational environments, including wind tunnels, water channels, towing tanks, pipe systems, flow cells, and microfluidic devices, where the “substance” may refer to air, water, oil, blood, or other single-phase or multiphase media. The tracer 136 can be suspended within the substance, float on the surface of the substance, or be transported along the inner wall surface 9. In some embodiments, the tracer 136 exhibits minimal drag to avoid resisting the substance’s motion. In other embodiments, the tracer 136 may impart some drag, resulting in tracer movement at a velocity lower than that of the surrounding flow. The tracer material, shape, and density may be engineered to ensure accurate flow tracking while minimizing signal interference or flow disturbance. The choice of tracer injection mechanism, dosing rate, and timing may be optimized for the specific commercial application (e.g., rapid seeding for wind‑tunnel tests or continuous low‑dose injection for industrial process monitoring).

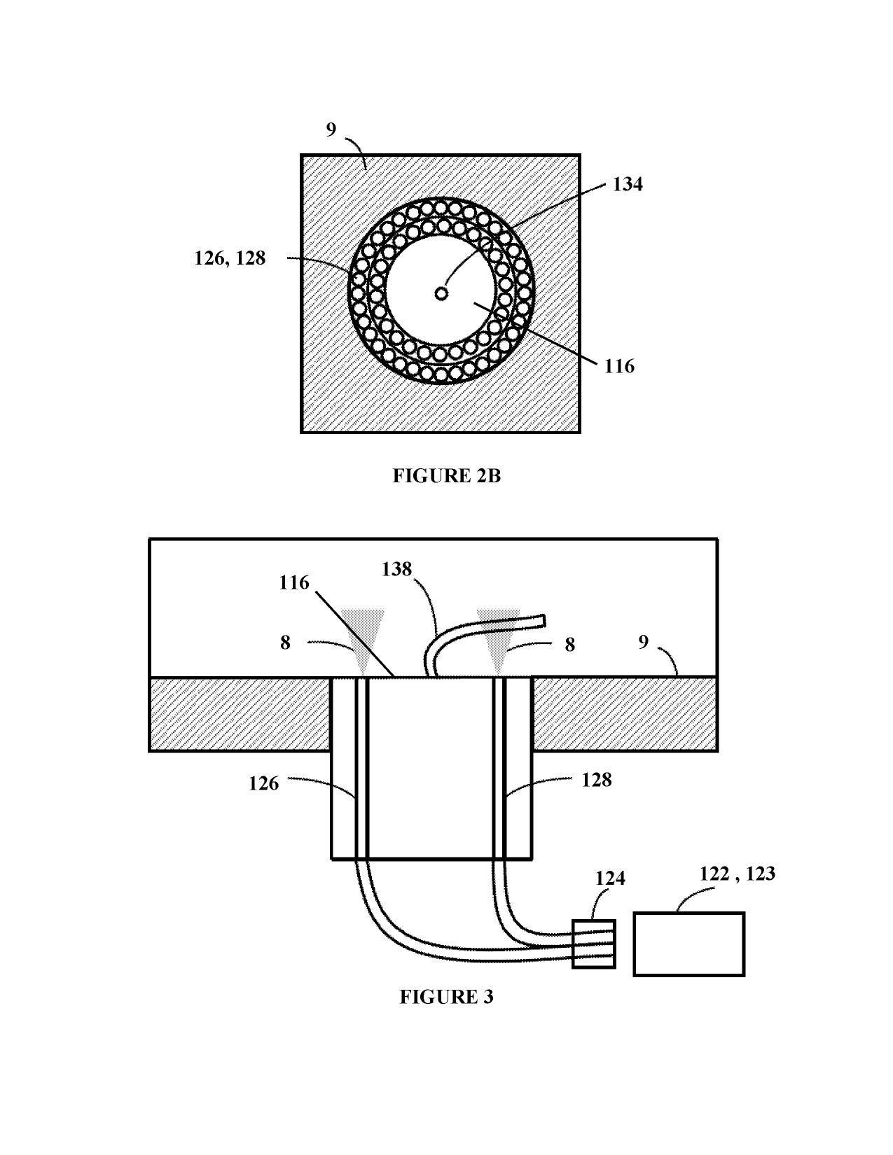

FIG. 2A shows one example embodiment of the device 100, from a top view, showing the wall inner surface 9, the optical fiber distal end surfaces of the first and second fiber bundles 126, 128, and the injector distal end 134. As illustrated, the fibers 126, 128 can be arranged in a circle, with the first set of fibers 126 in an alternating repeating pattern with the second set of fibers 128, such as one or more first fibers 126, then one or more second fibers 128, then one or more first fibers 126, and so on. In addition, the tracer injector 134 is shown at the center of the circle of first and second fibers 126, 128. This layout simplifies tracer delivery and optical alignment in commercially built systems, reducing calibration and installation complexity.

FIG. 2B shows another example embodiment, having two fiber circles, namely an inner circle and an outer circle concentrically arranged, and here directly adjacent to one another. One circle (e.g., the outer one) can comprise only the first set of fibers 126, and the other circle (e.g., the inner one) can comprise only the second set of fibers 128. Or, each circle can include an alternating repeating pattern of the first and second fibers 126, 128, and the first fibers 126 in the outer circle can at least partially align with the first fibers 126 in the inner circle and be at least partially offset from the second fibers in the inner circle. Or the first fibers 126 in the outer circle can be at least partially offset from the first fibers 126 in the inner circle, and at least partially align with the second fibers 128 in the inner circle. The fibers in the inner circle are adjacent to the fibers in the outer one. Other suitable configurations can be provided, for example, the fibers can have fixed patterns, or be randomized. This flexibility enables adaptation to different flow geometries and spatial resolution requirements in commercial and research applications.

In the embodiments of FIGS. 2A, 2B, the first set of fibers 126 is close (and here adjacent) to the second set of fibers 128. And more specifically, the first set of fibers 126 is illuminating the same area 8 at which the second set of fibers 128 is receiving collected light from the tracer particles 136. So, the second fibers 128 are within the illumination area 8 provided by the first fibers 126. This overlapping illumination/detection region supports high signal-to-noise and improves measurement accuracy by ensuring consistent tracer illumination and detection across all angular positions.

Referring to FIG. 3, another example embodiment of the device 100 is shown in which the tracer 136 is a filament or string 138. Comparing FIG. 3 with FIG. 1, there is no need for a tracer source 132 or injector 134. Instead, the tracer filament or string 138 has a string proximal end and a string distal end. The string proximal end is fixedly attached to the probe front surface 116 at the center of the fiber optic ring(s), and the string distal end is free. Accordingly, the string distal end can move near the wall inner surface 9, in response to the flow or motion of a substance at the wall inner surface 9. The filament or string 138 can at least partially float on the substance surface, be at least partly suspended in the substance, or be dragged at the bottom of the substance along the wall inner surface 9. This configuration enables completely passive operation with no active injection, and can be used in long-duration measurements or in closed-loop systems where introducing tracer material is impractical.

In all configurations, the tracer system may be fabricated from industry‑standard, commercially available components (such as precision metering pumps, aerosol generators, dye injection kits, tracer particles, tubing, valves and cartridges) and be produced at scale using conventional manufacturing techniques. The integration of tracer injection, illumination, and detection within a single probe body facilitates turnkey installation, minimal training, and simplified maintenance for industrial, laboratory, or field use.

### Operation

In an example operation, the device 100 is utilized to measure the flow or velocity of a substance (e.g., gas, liquid, gel, or other fluid) that is present at the wall inner surface 9 of the wall 5. Initially, a tracer 136 is introduced at a fixed location along the wall inner surface 9 to interact with the substance. The tracer 136 may mix with the substance, partially dissolve within it, or remain physically separate. In one embodiment, as illustrated, the injector 134 delivers the tracer 136 orthogonally outward from the distal end surface of the housing. However, the tracer 136 may be introduced in any suitable manner, including via injector 134 configurations such as those shown in FIGS. 1-2. In alternative embodiments, the injector need not lie in the same plane as the wall inner surface 9; but instead the injector 134 can be located to face the wall inner surface 9 and introduce the tracer 136 toward the wall inner surface; for example the injector 134 can be located above the wall inner surface 9 (when the wall is horizontal) or to the side of the wall inner surface 9 (when the wall is vertical), and held in position by a fastener mechanism (e.g., a clamp, clip, adapter, support, adhesive or the like) that attaches to the wall 5 or a separate support. And in still further embodiments, the injector 134 can be located at an acute or obtuse angle with respect to the substance and the wall inner surface 9, and need not be orthogonal.

As noted, in one embodiment, the first set of one or more optical fibers 126 delivers light from the light source 122 at a first optical fixed location, via the faceplate 124, to project outward from the first fiber distal end surfaces, into the illuminated area 8. And, the second set of one or more optical fibers 128 receives light at a second optical fixed location at the second distal end surface, that is scattered, re-emitted, or back-reflected from the particle tracers 136, and delivers the collected light, via the faceplate 124, to the optical imager 123. The first and second optical locations can be adjacent to one another or separate, and are separated from the injector location. Though the fibers 126, 128 are shown fully encircling the injector 134 distal end, the fibers 126, 128 need not fully surround the injector 134, and can instead partly surround the injector 134 or can be arranged linearly, downstream from the injector location.

Accordingly, once the tracer 136 is introduced, it travels in the direction of the substance flow. The light source 122 illuminates test area 8 with light from the first optical fibers 126. Once the tracer 136 reaches one of the detection areas 8, it interacts with the incident light from the first optical fibers 128, causing reflection, scattering, or re-emission (e.g., fluorescence or phosphorescence). The resulting optical signal is then collected by the second optical fibers 128 and transmitted to the imager 123. While some light may also reflect or scatter from the surrounding substance or wall surface, the tracer 136 is designed or selected to produce a distinguishable optical signature, such as through spectral emission, intensity, polarization, or temporal response, that enables differentiation from background signals. Appropriate optical filters, timing mechanisms, or signal processing algorithms may be used to isolate tracer-specific light and ensure accurate velocity measurement.

The imager 123 then determines properties of the substance flow, such as direction and velocity, based on the observed motion of the tracer 136 over time within the illuminated region. Depending on the configuration, this may include measuring the time between tracer appearances at known spatial locations (time-of-flight), tracking displacement across successive detection points, or monitoring the trajectory of the tracer within a defined optical field. In some embodiments, the tracer may be a tethered element, such as a filament or string affixed at one end to the wall surface, where its oscillation or deflection in response to the flow provides a direct visual cue of near-wall motion and directionality. This wall-attached configuration can offer a passive and robust solution, especially for low-speed or high-viscosity flows.

The system may also employ multiple detection points spaced along the flow direction, allowing the imager 123 to determine the tracer’s displacement over time and compute velocity based on positional tracking. Flow direction may be inferred from the sequence of detections across spatially separated optical paths or by analyzing the motion vector of the tracer within the illuminated field.

Image processing or optical signal analysis techniques, such as centroid tracking, correlation-based methods, or spectral analysis, may be applied by the imager 123, or by an operator using imager data, to isolate the tracer signal and determine relevant flow characteristics. This enables accurate characterization of near-wall flow behavior, including streamline orientation, flow speed, and shear gradients. In certain configurations, the system may be capable of detecting time-varying or unsteady flows, including oscillatory or pulsatile motion, by analyzing multiple tracer events over time. Shear stress at the wall inner surface 9 may be estimated by calculating the velocity gradient normal to the surface, based on the movement of tracers across closely spaced detection locations. Additionally, the system may be configured to resolve multi-dimensional velocity vectors, for example by using multiple illumination and detection paths oriented at different angles relative to the wall or flow.

Beyond flow-related quantities, the system may also be configured to detect scalar field properties, such as temperature, pH, chemical concentration, or other environmental parameters, by employing tracer materials that exhibit optically detectable changes in response to local conditions. For example, fluorescent dyes, colorimetric indicators, or luminescent tracers may be used to encode information about local temperature or chemical composition within the near-wall region. These scalar measurements may be extracted through spectral analysis, intensity mapping, or other imaging-based methods.

Calibration procedures may be employed to correct for variations in tracer introduction timing, fiber alignment, or optical distortion, thereby improving measurement accuracy and repeatability. However, in certain implementations, the system may operate in a calibration-free mode, relying on fixed geometries and known optical characteristics to enable immediate deployment without the need for user calibration. The resulting data may be used to generate velocity profiles, streamline maps, shear distributions, or time-resolved flow field visualizations for further analysis or system optimization.

The above-described measurement techniques may be applied to a wide variety of flow scenarios and substances. As used herein, the term “substance” may refer to any material present at the wall or boundary surface whose motion is to be measured, including but not limited to fluids (liquids or gases), solids (e.g., particulates), gels, emulsions, foams, slurries, or other single-phase or multiphase media. Such flows may occur in a broad range of test and operational environments, including but not limited to wind tunnels, water channels, towing tanks, pipe systems, flow cells, and microfluidic devices. The substance may include air, water, oil, blood, or any other media whose flow behavior near a surface is of interest.

To facilitate measurement, the system may utilize a variety of tracer types depending on the characteristics of the flow and the measurement objectives. In some embodiments, the tracers may be physical filaments, such as thin strands of polymer or textile material, which are particularly effective in slow or viscous flows, where their elongated shape allows for clear directional tracking. In other cases, chains of beads, comprising strings of small, often spherical elements, may be employed in turbulent or high-density flows to improve optical tracking under complex flow conditions. In liquid media, gas bubbles may serve as effective tracers, particularly when the liquid is transparent or when buoyancy-enhanced contrast is desirable. Conversely, in gaseous environments or opaque fluids, liquid droplets may be used to trace flow paths. Dye patches, which may be introduced as colored or fluorescent regions, can be particularly useful in slow or optically clear flows, where diffusion is minimal. Solid particles, including microspheres or natural particulates, may also be employed in fast or dense flows, providing robust signal strength and compatibility with a range of detection methods. In some scenarios, the system may rely on naturally occurring tracers already present in the flow, eliminating the need for tracer introduction altogether. These may include existing particles, refractive index variations, or naturally entrained bubbles or droplets. This can be especially advantageous in applications where introducing foreign materials is undesirable, such as in biomedical, environmental, or food-grade systems. The system’s compatibility with this broad range of tracers and substances enables high-precision near-wall flow measurement across diverse operational contexts, without being limited to a particular fluid type, flow regime, or measurement condition.

Thus, the device 100 provides an optical-based approach in which all optical components, including illumination and detection elements, can be integrated into a compact package suitable for measuring flow velocities in the near-wall region. As used herein, “near-wall” may refer to distances from the wall surface on the order of approximately 1 to 100 micrometers, though larger or smaller distances may also be encompassed depending on the optical configuration and application requirements. In some embodiments, the probe may resolve flow characteristics at distances less than 1 µm or greater than 100 µm from the wall, depending on the fiber optics geometry, tracer properties, and the imaging system's resolution.

The spatial arrangement and optical coverage of the optical fibers determine the type, resolution, and nature of flow measurements that can be obtained. In some embodiments, the fibers are implemented as part of a fiber bundle and may be arranged in various geometric configurations depending on the application. For example, a linear configuration may be used to provide a narrow, directional field of view, particularly suited for flows that are uniform and unidirectional. An arc configuration may enable a partial circular field of view, useful for capturing tracers moving along curved paths, where flow direction changes predictably. A ring configuration may provide a 360-degree field of view around the probe, allowing for omnidirectional tracer detection, particularly in radial or recirculating flows. An array configuration, such as a regular or irregular grid, may be used to monitor complex or multidirectional flows with varying velocity vectors in the near-wall region. These configurations define the optical coverage of the probe; that is, the illuminated and observed region within which tracer motion can be detected. The extent and shape of this coverage directly influence which quantities can be measured. For instance, flow direction can be resolved using ring, arc, or linear fiber arrangements that detect directional tracer movement across the field of view. Velocity near the wall can be determined using configurations that emphasize spatial displacement or time-of-flight across offset detection points. Narrow fields of view near the surface can improve resolution in high-speed boundary layers, while wider fields of view extending away from the wall can enable velocity gradient estimation. More advanced configurations, such as concentric rings, staggered lines, or angularly offset fiber groups, may allow for the simultaneous measurement of flow direction, velocity magnitude, and spatial gradients, enabling the extraction of quantities such as wall shear stress, turbulence intensity, or unsteady flow features. These arrangements may be used individually or in combination: for example, a ring may be supplemented with lines or arcs, or an array may incorporate localized rings, to provide more comprehensive sampling of the flow field. The selection and arrangement of the fiber bundle may be tailored to the geometry of the surface, the expected flow conditions, and the measurement objectives. In some embodiments, the fiber configuration may be adjustable or reconfigurable, allowing the probe to be adapted to different applications or optimized for specific measurement targets. When paired with appropriate imaging and processing techniques, the fiber bundle may support three-dimensional flow reconstruction, time-resolved measurements, or multi-modal sensing. Furthermore, the fibers within the bundle may be configured for dual functionality, serving as both illumination and imaging channels depending on the optical routing and system design.

The system may be implemented in a compact, calibration-free probe architecture, making it suitable for deployment in confined or harsh environments. The use of the fiber bundle also enables remote or distributed sensing, as well as mechanical flexibility for integration into complex geometries.

The measurement domain near the probe must be illuminated to enable optical detection of the tracer 136. Illumination can be provided by a light source that is either external to the probe or embedded within it. In embedded configurations, light delivery may be achieved through optical fibers integrated into the probe body. In some embodiments, a single fiber may serve both for illumination and detection, with optical separation managed via a beamsplitter or a wavelength-selective optics positioned along the optical path. In other embodiments, the illumination and detection functions are decoupled, with separate fibers or optical components assigned to each. Various illumination strategies may be employed depending on the desired spatial resolution, tracer type, and optical geometry. These include broad-field (or wide-field) illumination, in which a large area is uniformly illuminated to observe tracer motion across an extended region; dark-field illumination, where light is directed at an oblique angle to minimize background interference and enhance tracer contrast; evanescent wave illumination, where light is confined to a sub-wavelength region near the wall surface to selectively excite tracers in close proximity; and total internal reflection-based techniques, which produce highly localized illumination at the interface. Additional approaches include fluorescence or phosphorescence excitation, where tracers are activated by specific wavelengths of light, and collimated or focused beams delivered through integrated lenses or micro-optics within the probe. Illumination may also be delivered externally, using free-space optics, fiber-coupled sources, or through transparent regions or windows in the probe structure. The selected illumination method may vary based on environmental conditions such as fluid opacity, spatial constraints, or the need for high temporal or spatial resolution. In some cases, hybrid strategies may be used to switch between different illumination modes or to combine internal and external light sources during operation.

The technique is compatible with a wide range of wavelengths across the electromagnetic spectrum, including ultraviolet (UV), visible, and infrared (IR) light. The illumination may be monochromatic (e.g., using a laser source to excite fluorescence at a specific wavelength) or polychromatic, such as with an LED or broadband lamp, depending on the tracer characteristics and detection method.

The device 100 may also be configured to provide depth-resolved measurements. In some embodiments, this is achieved by exploiting the dispersive and absorptive properties of the medium to enable multimodal sensing. For example, at wavelengths near 2.9 μm, water exhibits strong absorption, and the intensity of light scattered or re-emitted by the tracers may vary with their depth within the medium. This depth-dependent signal attenuation can be used to infer the tracer’s distance from the wall. In certain configurations, this sensing approach may be combined with time-of-flight techniques or optical coherence tomography (OCT) to enhance spatial resolution in the direction normal to the wall. Additionally, ultrafast laser sources may be used in a time-gated or LIDAR-based mode to directly measure the distance of individual tracers from the wall surface. This approach may be integrated with the existing time-of-flight or displacement-based velocimetry system to provide simultaneous velocity and depth profiling in the near-wall region.

In some embodiments, multiple optical fibers may share overlapping fields of view within the illuminated domain. This configuration enables depth resolution through triangulation, wherein the relative signal intensities or detection timings across different fiber views are used to infer the three-dimensional position of the tracer. In other embodiments, single-mode fibers, including polarization-maintaining fibers, may be employed to generate interferometric signals. These can produce interferograms that encode depth information, either directly or through structured illumination techniques. For example, phase or amplitude modulation of the illumination signal across the fiber array may be used to encode spatial depth variations in the detected signal. Additionally, depth discrimination can be achieved through non-uniform illumination, such as by selectively controlling the light input into specific fibers to create spatially varying excitation patterns.

A variety of optical sensors may be employed to detect the light collected by the fiber bundles, with the choice of sensor tailored to the specific requirements of the application. Suitable sensors include camera arrays, such as CMOS or CCD imaging sensors, which may be arranged in specific configurations to capture high-resolution images of light scattered by tracers as they move with the flow. These images can be analyzed to resolve detailed flow structures and provide precise velocity measurements near the surface boundary. In some embodiments, photodiodes may be used as detection elements. These semiconductor devices convert incident light into electrical current and may be particularly effective in applications requiring fast response times or simplified signal processing. The electrical output generated by photodiodes in response to scattered or re-emitted tracer light can be analyzed to determine local flow velocity. The system may also incorporate event-based cameras, which detect changes in the optical scene in real time and are particularly advantageous for transient or high-speed flows, where continuous, low-latency monitoring is essential.

To enhance measurement accuracy, the system may incorporate one or more optical filters positioned between the fiber bundle and the sensors. These filters selectively transmit or block specific wavelengths, polarizations, or time windows of light, enabling improved isolation of the tracer signal from background noise or interference. Filter types may include bandpass filters, which allow only a narrow wavelength range (e.g., a tracer’s emission peak) to pass; notch filters, which block a specific wavelength to eliminate interference (e.g., from a laser source); and polarizing filters, which transmit light of a specific polarization to exploit directional scattering behavior. In some cases, time-gated filters or dynamic filters may be used to further suppress background or enable temporal signal separation. In certain embodiments, these optical filters may be integrated directly into the fiber bundles. This integration may involve the use of filter-coated fiber tips, multi-core fibers with built-in spectral filtering, or microscale filter components positioned along the optical path. Integrating filters at the fiber level may reduce the need for bulky external optics, allowing for a more compact, rugged, and easily deployable probe design suitable for confined or harsh environments.

Additionally, the fiber bundle may include multiple channels or groups of fibers with differing parameters. For example, individual fibers or fiber groups may be coupled to different types of sensors, fitted with distinct optical filters, or designed with varied numerical apertures, core diameters, or collection angles to tailor depth of field, sensitivity, or spatial resolution. This modularity enables parallel, multi-modal sensing of various optical properties associated with the tracers and surrounding medium, including velocity, direction, intensity, and scalar field characteristics.

In various embodiments, the near-wall velocimetry probe may be configured to measure flow velocity at surface boundaries under a wide range of conditions. The probe may be deployed in both static and dynamic scenarios, enabling accurate measurements even when the wall surface or the surrounding fluid is in motion or undergoing temporal changes. It may be used in flows exhibiting different regimes, including laminar, transitional, and turbulent flow, while maintaining high precision and spatial resolution near the wall. The probe may also be suitable for use in both single-phase flows, such as pure liquids or gases, and multiphase flows, including gas–liquid mixtures, liquid–solid suspensions, or emulsions. Furthermore, the system may accommodate a broad range of flow velocities, from very low speeds on the order of millimeters per second (e.g., in microfluidic systems) to high-speed flows exceeding tens of meters per second (e.g., in industrial or aerodynamic applications), depending on the tracer dynamics and system configuration. These capabilities enable the probe to perform reliable and accurate near-wall velocimetry across a wide spectrum of application scenarios, offering a versatile solution for measuring surface-boundary flow characteristics in laboratory, industrial, and field environments.

In some aspects, the near-wall velocimetry probe may be designed with a structure that enables flush mounting on a variety of surface geometries. This design feature allows the probe to be seamlessly integrated into the wall or boundary surface, thereby minimizing disruption to the surrounding flow. By eliminating protrusions or discontinuities, flush mounting may enhance measurement accuracy and repeatability by reducing flow disturbances and potential sources of measurement error.

In some cases, the probe may be designed with an integrated optical system positioned within the probe housing. This system may include one or more optical components (e.g., lenses, mirrors, prisms, beam splitters, or optical filters) configured to manipulate the light used for velocimetry measurements. These components may be arranged along the optical path between the light source and the fiber bundle for illumination, or between the fiber bundle and the detector for signal collection. The integrated optics system may be designed to direct light toward the tracers in the flow, collect the tracers’ optical signature, or perform both functions, depending on the configuration. In certain embodiments, the optical and imaging components are enclosed within the probe body and protected from the external environment. This sealed or shielded design may be particularly beneficial in harsh or corrosive conditions, such as those involving salt water, acidic solutions, pressurized systems, or high-temperature fluids. The system may also be configured for remote operation, allowing control of illumination parameters, image acquisition, or data transmission without direct access to the probe.

In some aspects, the probe may feature a modular architecture that allows optical elements and imaging sensors to be accessed, replaced, or upgraded without altering the overall form factor. This modularity provides flexibility for adapting the probe to various measurement requirements, fluid types, or system geometries, and facilitates the incorporation of advancements in optical or imaging technologies.

It is noted that the system is described as having a remotely-located light source and a remotely-located imager, and fiber optics for transmitting light from the light source to the detection area and from the detection area to the imager, respectively. However, it will be appreciated that other configurations are possible. For example, other light-transmitting components (other than fiber optics) can be utilized to transmit light from the light source to the detection area and from the detection area to the imager. Or, the light source can be mounted to or embedded within the probe housing at the inner wall surface to directly transmit light into the detection area without the need for light-transmitting components. Likewise, the imager can be mounted to or embedded in the probe housing to directly collect light at the inner wall inner surface, without light-transmitting components.

It should be understood that various geometric, relational, directional, or positional terms may be used throughout the description and figures for ease of reference and illustrative clarity. These terms are intended to facilitate understanding of the embodiments and are not to be read as limiting the scope of the disclosure. Moreover, such descriptors may refer to approximate or idealized conditions; for example, surfaces may be described as flat or perpendicular even if they exhibit roughness, curvature, or manufacturing tolerances, and may still be considered substantially flat or perpendicular for the purposes of this disclosure.

The foregoing description and accompanying drawings are intended to be illustrative rather than limiting. The disclosed systems and methods may be implemented in a variety of forms, shapes, and configurations beyond those explicitly described. Numerous variations, modifications, and alternative embodiments will be apparent to those skilled in the art, and all such equivalents are intended to fall within the scope of this disclosure.

1. A near-wall velocimetry probe, comprising:
a probe body configured for flush mounting on a surface;
at least one tracer source mounted to or integrated within the probe body; at least one tracer source configured to introduce tracers into a flow near the surface
at least one fiber bundle mounted to or integrated within the probe body configured to capture optical signals reflected, scattered, or emitted from the tracers; and
at least one detector optically coupled to the at least one fiber bundle, wherein the at least one fiber bundle is configured to receive optical signals reflected, scattered, or emitted from the tracers.

2. The near-wall velocimetry probe of claim 1, wherein the at least one fiber bundle is arranged in a configuration that comprises a ring, multiple concentric rings, a line, an arc, or an array.

3. The near-wall velocimetry probe of claim 1, wherein the tracers comprise any one or more of physical filaments, chains of beads, gas bubbles, liquid droplets, dye patches, particles, and naturally present tracers in the flow.

4. The near-wall velocimetry probe of claim 1, further comprising an illumination source configured to illuminate the tracers.

5. The near-wall velocimetry probe of claim 4, wherein the illumination source is embedded within the probe body.

6. The near-wall velocimetry probe of claim 5, wherein the illumination source comprises fiber optics integrated into the at least one fiber bundle.

7. The near-wall velocimetry probe of claim 1, further comprising at least one optical filter coupled to the at least one fiber bundle, wherein the at least one optical filter is configured to selectively transmit the optical signals reflected, scattered, or emitted from the tracers.

8. A method for measuring near-wall flow velocity, comprising:
introducing tracers into a flow at a known location adjacent to a surface;
collecting optical signals reflected, scattered, or emitted from the tracers using at least one fiber bundle positioned near the surface; and
analyzing the captured optical signals to determine flow velocity near the surface.

9. The method of claim 8, wherein the tracers comprise any one or more of physical filaments, chains of beads, gas bubbles, liquid droplets, dye patches, and particles.

10. The method of claim 8, wherein capturing the optical signals reflected, scattered, or emitted from the tracers comprises using at least one fiber bundle arranged in a configuration selected from any one or more of a ring, multiple concentric rings, a line, an arc, and an array.

11. The method of claim 8, further comprising illuminating the tracers using an illumination source embedded within a probe body.

12. The method of claim 11, wherein the illumination source comprises fiber optics integrated into the at least one fiber bundle.

13. The method of claim 8, further comprising filtering the captured light using at least one optical filter coupled to the at least one fiber bundle.

14. The method of claim 13, wherein analyzing the captured light comprises determining flow direction and magnitude based at least in part on the captured or filtered optical signals captured by the at least one fiber bundle.

15. A system for near-wall velocimetry, comprising:
a probe body configured for flush mounting on a surface;
a tracer source mechanism configured to introduce tracers into a flow near the surface;
a plurality of optical fibers arranged in a pattern on the probe body to receive light from the tracers; and
an imaging device optically coupled to the optical fibers and configured to capture optical data corresponding to tracer motion near the surface.

16. The system of claim 15, wherein the pattern of optical fibers comprises at least one configuration of a ring, multiple concentric rings, a line, an arc, or an array.

17. The system of claim 15, wherein the tracer source mechanism is configured to introduce tracers that comprise any one or more of physical filaments, chains of beads, gas bubbles, liquid droplets, dye patches, and particles.

18. The system of claim 15, further comprising an illumination source embedded within the probe body and configured to illuminate the tracers.

19. The system of claim 18, wherein the illumination source comprises fiber optics integrated into the plurality of optical fibers.

20. The system of claim 19, further comprising at least one optical filter coupled to the plurality of optical fibers, wherein the at least one optical filter is configured to selectively transmit the tracers’ optical signature.
